(19) United States
(12) Patent Application Publication
(10) Pub. No.: US 2021/0190203 A1
(43) Pub. Date: Jun. 24, 2021

(54) TRANSMISSION HYDRAULIC CONTROL SYSTEM

(71) Applicant: GM Global Technology Operations LLC, Detroit, MI (US)

(72) Inventors: Edward W. Mellet, Rochester Hills, MI (US); Leonid Basin, Farmington HIlls, MI (US); Kelly Eber, Oxford, MI (US)

(21) Appl. No.: 16/723,242

(22) Filed: Dec. 20, 2019

(51) Int. Cl. F16H 61/00; F16H 61/30

(52) U.S. Cl. CPC F16H 61/0025; F16H 61/30; F16H 2708/20; F16H 2061/305; F16H 2061/0034

(57) ABSTRACT

A transmission hydraulic control system for an automobile transmission includes a hydraulic circuit in fluid communication with the at least one torque transmitting device, a transmission pump in fluid communication with the hydraulic circuit and adapted to provide pressurized hydraulic fluid to the hydraulic circuit, an accumulator in fluid communication with the hydraulic circuit and having an annular cylindrical shape concentric with a center-line of the automatic transmission, an annular piston moveable between a first position and a second position, and a spring adapted to bias the piston to the first position, and a valve mechanism positioned between the hydraulic circuit and the accumulator, the valve mechanism adapted to selectively allow fluid communication between the accumulator and the hydraulic circuit.

### INTRODUCTION

The present disclosure relates to a hydraulic control system for an automatic transmission in an automotive vehicle.

A typical automatic transmission includes a hydraulic control system that, among other functions, is employed to actuate a plurality of torque transmitting devices. These torque transmitting devices may be, for example, friction clutches and brakes. The conventional hydraulic control system typically includes a main pump that provides a pressurized fluid, such as oil, to a plurality of valves and solenoids within a valve body. The main pump is driven by the engine of the motor vehicle. The valves and solenoids are operable to direct the pressurized hydraulic fluid through a hydraulic fluid circuit to the plurality of torque transmitting devices within the transmission. The pressurized hydraulic fluid delivered to the torque transmitting devices is used to engage or disengage the devices in order to obtain different gear ratios.

In order to increase the fuel economy of automotive vehicles, it is desirable to stop the engine during certain circumstances, such as when stopped at a red light or idling. However, during this automatic stop, the transmission pump is no longer driven by the engine. Accordingly, hydraulic fluid pressure within the hydraulic control system drops. This leads to clutches and/or brakes within the transmission becoming disengaged. As the engine restarts, these clutches and/or brakes may take time to reengage fully, thereby producing slippage and delay between engagement of the accelerator pedal or release of the brake and the movement of the motor vehicle.

In some cases, these transmissions have a separate auxiliary electric pump for providing the pressurized hydraulic fluid when the engine is turned off. The auxiliary electric pump maintains hydraulic fluid pressure to keep selected clutches and/or brakes within the transmission engaged when the engine and the transmission pump are not providing hydraulic pressure to the system. As the engine restarts, these clutches and/or brakes are fully engaged, preventing slippage and delay between engagement of the accelerator pedal or release of the brake and the movement of the automotive vehicle.

In some cases, these transmissions use an accumulator to remotely store pressurized hydraulic fluid when the engine is turned off. When the engine and the transmission pump are running, the accumulator is charged with pressurized hydraulic fluid from the hydraulic circuit. When the engine and the transmission pump are turned off, a valve holds pressurized hydraulic fluid within the accumulator. As the engine restarts, pressurized hydraulic fluid is released from the accumulator into the hydraulic circuit. This injection of pressurized hydraulic fluid engages clutches and brakes within the transmission, preventing slippage and delay between engagement of the accelerator pedal or release of the brake and the movement of the automotive vehicle as the engine restarts.

Thus, while conventional hydraulic control systems are effective, there is a need for an improved hydraulic control circuits that does not rely on an auxiliary electric pump or a remotely located accumulator to provide hydraulic pressure to the hydraulic circuit during engine restart.

### SUMMARY

According to several aspects of the present disclosure, a transmission hydraulic control system for actuating at least one torque transmitting device in a transmission for an automobile includes a hydraulic circuit in fluid communication with the at least one torque transmitting device, a transmission pump in fluid communication with the hydraulic circuit and adapted to provide pressurized hydraulic fluid to the hydraulic circuit, an accumulator including an inner volume in fluid communication with the hydraulic circuit, the inner volume having an annular cylindrical shape concentric with a center-line of the automatic transmission, an annular piston positioned within the inner volume, the piston moveable between a first position and a second position, and a spring adapted to bias the piston to the first position, and a valve mechanism positioned between the hydraulic circuit and the accumulator, the valve mechanism adapted to selectively allow fluid communication between the inner volume of the accumulator and the hydraulic circuit, and to prevent fluid communication between the inner volume of the accumulator and the hydraulic circuit, wherein the valve mechanism allows pressurized hydraulic fluid to enter the inner volume of the accumulator when the transmission pump is running, the valve mechanism holds pressurized hydraulic fluid within the inner volume of the accumulator when the transmission pump is not running, and the valve mechanism selectively releases pressurized hydraulic fluid from the inner volume of the accumulator to the hydraulic circuit.

According to another aspect, the valve mechanism includes a first control device and a second control device, the first control device adapted to allow pressurized hydraulic fluid to enter the inner volume of the accumulator from the hydraulic circuit, the second control device adapted to selectively allow pressurized hydraulic fluid to flow from the inner volume of the accumulator to the hydraulic circuit.

According to another aspect, the first and second control devices are located within a control valve body of the transmission.

According to another aspect, the first control device is a one-way ball check valve that allows fluid communication from the hydraulic circuit to the accumulator and prevents fluid communication from the accumulator to the hydraulic circuit.

According to another aspect, the second control device is a selectively actuatable valve having an open condition for allowing fluid communication between the inner volume of the accumulator and the hydraulic circuit and a closed condition for preventing fluid communication between the accumulator and the hydraulic circuit.

According to another aspect, the second control device is an on/off solenoid.

According to another aspect, the spring biases the piston to the first position with a biasing force, and wherein the pressurized hydraulic fluid within the hydraulic circuit when the transmission pump is running is sufficient to overcome the biasing force of the spring such that when pressurized hydraulic fluid enters the inner volume of the accumulator the piston moves from the first position to the second position.

According to another aspect, when the transmission pump is not running and the valve mechanism is selectively actuated to allow fluid communication between the inner volume of the accumulator and the hydraulic circuit, the biasing force of the spring pushes the piston from the second position to the first position and forces hydraulic fluid within the inner volume of the accumulator into the hydraulic circuit.

According to another aspect, the valve mechanism is a selectively actuated pressure locking solenoid that is positioned within a control valve body of the transmission.

According to another aspect, the hydraulic control system further includes a controller adapted to send a start/stop signal to the valve mechanism to selectively actuate the valve mechanism.

According to several aspects of the present disclosure, a transmission hydraulic control system for actuating at least one torque transmitting device in a transmission for an automobile includes a hydraulic circuit in fluid communication with the at least one torque transmitting device, a transmission pump in fluid communication with the hydraulic circuit and adapted to provide pressurized hydraulic fluid to the hydraulic circuit, an accumulator including an inner volume in fluid communication with the hydraulic circuit, the inner volume having an annular cylindrical shape concentric with a center-line of the automatic transmission, an annular piston positioned within the inner volume, the piston moveable between a first position and a second position, and a spring adapted to bias the piston to the first position, and a valve mechanism positioned within a control valve body of the transmission between the hydraulic circuit and the accumulator, the valve mechanism adapted to selectively allow fluid communication between the inner volume of the accumulator and the hydraulic circuit, and to prevent fluid communication between the inner volume of the accumulator and the hydraulic circuit, wherein, when the transmission pump is running and the valve mechanism is selectively actuated to allow fluid communication between the hydraulic circuit and the inner volume of the accumulator, pressurized hydraulic fluid entering the inner volume of the accumulator is sufficient to overcome the biasing force of the spring and move the piston from the first position to the second position, increasing the capacity of the inner volume of the accumulator, and when the transmission pump stops running the valve mechanism is actuated to prevent fluid communication between the hydraulic circuit and the inner volume of the accumulator, and pressurized hydraulic fluid is held within the inner volume of the accumulator, and when the transmission pump is not running and the valve mechanism is selectively actuated to allow fluid communication between the hydraulic circuit and the inner volume of the accumulator, the biasing force of the spring pushes the piston from the second position to the first position and forces pressurized hydraulic fluid within the inner volume of the accumulator into the hydraulic circuit.

According to another aspect, the valve mechanism includes a first control device and a second control device, the first control device adapted to allow pressurized hydraulic fluid to enter the inner volume of the accumulator from the hydraulic circuit, the second control device adapted to selectively allow pressurized hydraulic fluid to flow from the inner volume of the accumulator to the hydraulic circuit.

According to another aspect, the first and second control devices are located within the control valve body of the transmission.

According to another aspect, the first control device is a one-way ball check valve that allows fluid communication from the hydraulic circuit to the accumulator and prevents fluid communication from the accumulator to the hydraulic circuit.

According to another aspect, the second control device is a selectively actuatable valve having an open condition for allowing fluid communication between the inner volume of the accumulator and the hydraulic circuit and a closed condition for preventing fluid communication between the accumulator and the hydraulic circuit.

According to another aspect, the second control device is an on/off solenoid.

According to another aspect, the valve mechanism is a selectively actuated pressure locking solenoid that is positioned within a control valve body of the transmission.

According to another aspect, the hydraulic control system further includes a controller adapted to send a start/stop signal to the valve mechanism to selectively actuate the valve mechanism.

According to several aspects of the present disclosure, a transmission hydraulic control system for actuating at least one torque transmitting device in a transmission for an automobile includes a hydraulic circuit in fluid communication with the at least one torque transmitting device, a transmission pump in fluid communication with the hydraulic circuit and adapted to provide pressurized hydraulic fluid to the hydraulic circuit, an accumulator including an inner volume in fluid communication with the hydraulic circuit, the inner volume having an annular cylindrical shape concentric with a center-line of the automatic transmission, an annular piston positioned within the inner volume, the piston moveable between a first position and a second position, and a spring adapted to bias the piston to the first position, and a selectively actuated pressure locking solenoid positioned within a control valve body of the transmission between the hydraulic circuit and the accumulator, the pressure locking solenoid adapted to selectively allow fluid communication between the inner volume of the accumulator and the hydraulic circuit, and to prevent fluid communication between the inner volume of the accumulator and the hydraulic circuit, wherein, when the transmission pump is running and the pressure locking solenoid is selectively actuated to allow fluid communication between the hydraulic circuit and the inner volume of the accumulator, pressurized hydraulic fluid entering the inner volume of the accumulator is sufficient to overcome the biasing force of the spring and move the piston from the first position to the second position, increasing the capacity of the inner volume of the accumulator, and when the transmission pump stops running the pressure locking solenoid is actuated to prevent fluid communication between the hydraulic circuit and the inner volume of the accumulator, and pressurized hydraulic fluid is held within the inner volume of the accumulator, and when the transmission pump is not running and the pressure locking solenoid is selectively actuated to allow fluid communication between the hydraulic circuit and the inner volume of the accumulator, the biasing force of the spring pushes the piston from the second position to the first position and forces pressurized hydraulic fluid within the inner volume of the accumulator into the hydraulic circuit.

According to another aspect, the hydraulic control system further includes a controller adapted to send a start/stop signal to the pressure locking solenoid to selectively actuate the valve mechanism.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic of a hydraulic control system in accordance with an exemplary embodiment;

FIG. 2 is a partial sectional view of a transmission having a hydraulic control system according to an exemplary embodiment;

FIG. 3 is a partial sectional view of an accumulator wherein a piston is in a first position; and

FIG. 4 is the partial sectional view of FIG. 3, wherein the piston is in a second position.

### DETAILED DESCRIPTION

The following description is merely exemplary in nature and is not intended to limit the present disclosure, application, or uses.

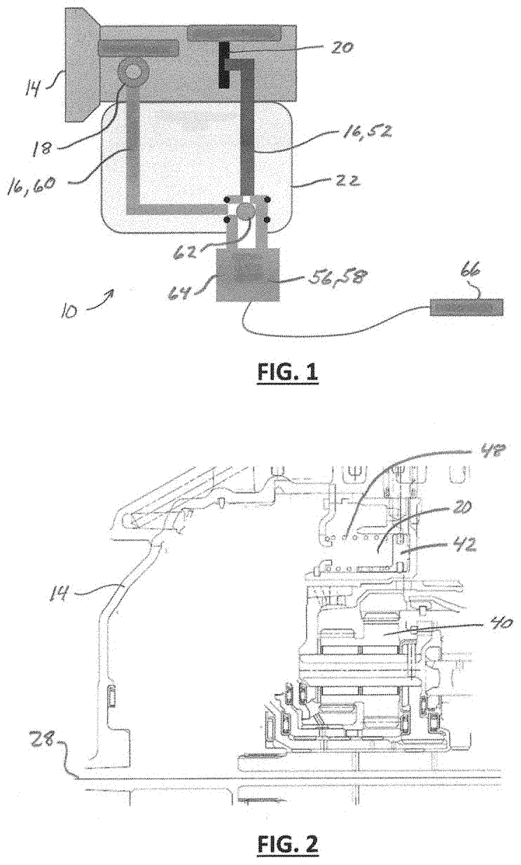

Referring to FIG. 1, a transmission hydraulic control system 10 for actuating at least one torque transmitting device 12 in a transmission 14 for an automobile includes a hydraulic circuit 16 in fluid communication with the at least one torque transmitting device 12, a transmission pump 18 in fluid communication with the hydraulic circuit 16 and adapted to provide pressurized hydraulic fluid to the hydraulic circuit 16, and an accumulator 20.

The at least one torque transmitting device 12 is hydraulically actuated by hydraulic fluid. The at least one torque transmitting device 12 may include a plurality of friction clutches and/or brakes, or other types of hydraulically actuated torque transmitting devices 12. The hydraulic fluid is, by way of non-limiting example, an oil conventionally used in automatic transmission systems.

The hydraulic control system 10 includes a reservoir or tank for receiving and storing the hydraulic fluid. The transmission pump 18 may take many forms, such as, by way of non-limiting example, an impeller pump, gear pump, or vane pump, without departing from the scope of the present invention. The transmission pump 18 is driven by an engine (not shown) in the automobile. The transmission pump 18 is operable to provide a flow of hydraulic fluid to the hydraulic circuit 16 of the transmission 14 and to the at least one torque transmitting device 12.

The hydraulic control system 10 further includes a control valve body 22. The control valve body 22 includes a plurality of passages and valves that control the flow of hydraulic fluid within the transmission 14 and to the torque transmitting devices 12 within the transmission 14. Selective actuation of the valves within the control valve body 22 controls actuation and de-activation of the torque transmitting devices 12.

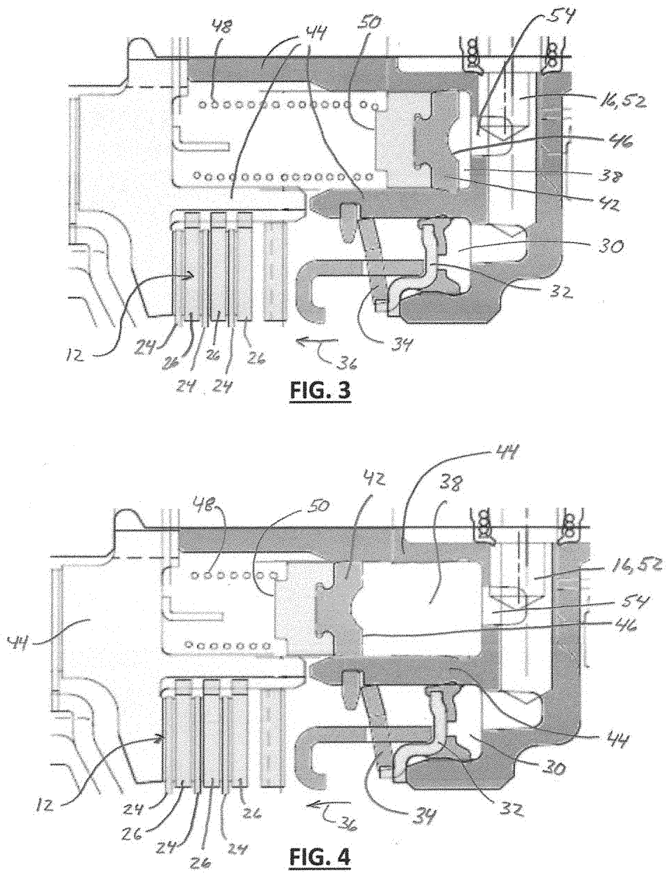

Referring to FIG. 3 and FIG. 4, in an exemplary embodiment, the at least one torque transmitting device 12 is a friction clutch that includes a plurality of alternating rotatable plates 24 and non-rotatable plates 26. The plates 24, 26 are generally flat annular shaped rings that extend circumferentially around and are concentric with a center line 28 of the transmission 14, as is common in automobile transmissions of this type. Actuation of the torque transmitting device 12 is accomplished by feeding pressurized hydraulic fluid from the hydraulic circuit 16 to a chamber 30. Positioned within the chamber 30 is a clutch piston 32. The clutch piston 32 is moveable between a first position and a second position within the chamber 30. A clutch spring 34 biases the clutch piston 32 to the first position, as shown in FIG. 3.

When pressurized hydraulic fluid is fed into the chamber 30, the hydraulic fluid overcomes the biasing force of the clutch spring 34 and pushes the clutch piston 32 from the first position toward a second position and toward the plurality of alternating rotatable and non-rotatable plates 24, 26, as indicated by arrow 36. An actuator 38 engages the stack of alternating rotatable and non-rotatable plates 24, 26, pushing the plates 24, 26 against one another. Friction between the rotatable and non-rotatable plates 24, 26 prevent the rotatable and non-rotatable plates 24, 26 from rotating relative to one another, thereby locking the rotatable plates 24 and engaging the torque transmitting device 12. To disengage the torque transmitting device 12, a valve within the control valve body 22 diverts the flow of pressurized hydraulic fluid from the chamber 30 allowing the clutch spring 34 to bias the clutch piston 32 away from the plurality of rotating and non-rotating plates 24, 26 and allowing the rotatable plates 24 to rotate relative to the non-rotating plates 26.

The accumulator 20 is an energy storage device in which the non-compressible hydraulic fluid is held under pressure. The accumulator 20 includes an inner volume 38 in fluid communication with the hydraulic circuit 16. The inner volume 38 has an annular cylindrical shape and is concentric with the center-line 28 of the automatic transmission 14. Referring to FIG. 2, the accumulator 20 is positioned circumferentially around and concentric with the center-line 28 of the transmission 14, as are other portions of the transmission 14, such as torque transmitting devices 12 and gear sets 40.

An annular piston 42 is positioned within the inner volume 38. The inner volume 38 is defined by rigid features 44 of the transmission 14 and a top surface 46 of the annular piston 42. The annular piston 42 is moveable between a first position, as shown in FIG. 3, and a second position, as shown in FIG. 4. A spring 48 is positioned to act on a bottom surface 50 of the annular piston 42 to bias the annular piston 42 toward the first position and to provide a compressive force on hydraulic fluid within the inner volume 38.

A branch 52 of the hydraulic circuit 16 within the transmission 14 provides fluid communication between the control valve body 22 and the accumulator 20. The accumulator 20 includes an inlet/outlet port 54 that allows hydraulic fluid to flow in and out of the accumulator 20.

A valve mechanism 56 controls the flow of hydraulic fluid to and from the accumulator 20. In an exemplary embodiment, a selectively actuated pressure locking solenoid 58 is positioned within the control valve body 22 of the transmission 14. The pressure locking solenoid 58 controls the flow of hydraulic fluid from a main line 60 of the hydraulic circuit 16 to the branch 52 that feed the accumulator 20. The pressure locking solenoid 58 selectively allows fluid communication between the inner volume 38 of the accumulator 20 and the hydraulic circuit 16, and prevents fluid communication between the inner volume 38 of the accumulator 20 and the hydraulic circuit 16.

In another exemplary embodiment, the valve mechanism 56 includes a first control device 62 and a second control device 64. The first and second control devices 62, 64 are located within the control valve body 22 of the transmission 14. The first control device 62 is adapted to allow pressurized hydraulic fluid to enter the inner volume 38 of the accumulator 20 from the hydraulic circuit 16. By way of non-limiting example, the first control device 62 may be a one-way ball check valve that passively allows fluid communication from the hydraulic circuit 16 to the accumulator 20 and prevents fluid communication from the accumulator 20 to the hydraulic circuit 16. The second control device 64 is adapted to selectively allow pressurized hydraulic fluid to flow from the inner volume 38 of the accumulator 20 to the hydraulic circuit 16. By way of non-limiting example, the second control device 64 may be a selectively actuatable valve, such as an on/off solenoid, having an open condition for allowing fluid communication between the inner volume 38 of the accumulator 20 and the hydraulic circuit 16 and a closed condition for preventing fluid communication between the accumulator 20 and the hydraulic circuit 16.

The hydraulic control system 10 operates in at least two modes: a first mode, wherein the transmission pump 18 provides pressurized hydraulic fluid to the at least one torque transmitting device 12, and a second mode, where the accumulator 20 provides pressurized hydraulic fluid to the at least one torque transmitting device 12 in order to engage the at least one torque transmitting device 12 when the motor vehicle engine is stopped. It should be appreciated that both modes of operation may occur simultaneously.

Generally, when the motor vehicle stops (i.e., at a red light for example), the engine shuts off and the transmission pump 18 stops rotating, so there is no pressure in the hydraulic circuit 16 providing pressurized hydraulic fluid to the at least one torque transmitting device 12. To start the motor vehicle without delay, the hydraulic circuit 16 should be filled with pressurized oil very fast. So, when the operator of the motor vehicle releases the brake pedal, or pushes on the accelerator pedal, a controller 66 sends an electric signal to the control valve body 22. The signal triggers the control valve body 22 to release the pressure locking solenoid 58, thereby allowing the accumulator 20 to discharge and send pressurized hydraulic fluid to the at least one torque transmitting device 12.

The inner volume 38 if the accumulator 20 volume is limited, and torque transmitting devices 12 have leakages, so the pressure of the hydraulic fluid from the accumulator 20 drops rapidly. A drop in pressure of the hydraulic fluid will cause slippage in torque transmitting devices 12, and the start of the motor vehicle can be delayed or slowed. Also, torque transmitting devices 12 can burn due to excessive slippage. Therefore, simultaneously with the signal sent to the pressure locking solenoid 58 to discharge the accumulator 20, another signal is sent to start the engine, which will drive the transmission pump 18. The transmission pump 18 will start to provide pressurized hydraulic fluid to the hydraulic circuit 16. In the very beginning, the engine and the transmission pump 18 are rotating relatively slowly, so the amount of pressurized hydraulic fluid going to the hydraulic circuit 16 is low and not sufficient to fully engage the torque transmitting devices 12. The main function of the accumulator 20 is to provide pressurized hydraulic fluid to the at least one torque transmitting device 12 very fast at high pressure for a short period of time and to minimize the delay of the motor vehicle start. After the engine starts, the transmission pump 18 will provide sufficient pressurized hydraulic fluid to operate the at least one torque transmitting device 12.

When the engine of the automobile is running and the transmission pump 18 is in operation, the pressure locking solenoid 58 is selectively actuated to allow fluid communication between the hydraulic circuit 16 and the inner volume 38 of the accumulator 20. Pressurized hydraulic fluid entering the inner volume 38 of the accumulator 20 is sufficient to overcome the biasing force of the spring 48 and move the annular piston 42 from the first position toward the second position, increasing the capacity of the inner volume 38 of the accumulator 20.

When the automobile comes to a stop, the start/stop system shuts off the engine of the automobile, and the transmission pump 18 no longer operates. This causes the pressure of the hydraulic fluid within the hydraulic circuit 16 to drop. When the pressure within the main line 60 drops below the pressure of the hydraulic fluid within the accumulator 20, the pressure locking solenoid the pressure locking solenoid 58 is actuated to prevent fluid communication between the main line 60 of the hydraulic circuit 16 and the branch 52 of the hydraulic circuit that feeds the inner volume 38 of the accumulator 20. This holds pressurized hydraulic fluid within the inner volume 38 of the accumulator 20 and the branch 52 of the hydraulic circuit 16 that feeds the accumulator 20 after the engine of the automobile is shut off and the transmission pump 18 is no longer operating, during a start/stop event.

When the operator of the motor vehicle releases the brake pedal, or pushes on the accelerator pedal, an electric signal is sent to the control valve body 22. The signal triggers the control valve body 22 to release the pressure locking solenoid 58, thereby allowing the accumulator 20 to discharge and send pressurized hydraulic fluid to the main line 60 of the hydraulic circuit 16. When the transmission pump 18 is not running and the pressure locking solenoid 58 is selectively actuated to allow fluid communication between the hydraulic circuit 16 and the inner volume 38 of the accumulator 20, releasing pressurized hydraulic fluid to the hydraulic circuit 16. The biasing force of the spring 48 pushes the annular piston 42 from the second position toward the first position and forces the pressurized hydraulic fluid within the inner volume 38 of the accumulator 20 into the hydraulic circuit 16.

A hydraulic control system 10 of the present disclosure offers several advantages. These include providing an accumulator 20 for a start/stop system within the transmission 14 of an automobile wherein the accumulator 20 is positioned internally and concentric with a center-line 28 of the transmission 14. In addition, the associated valve mechanism 56 that controls the accumulator 20 is positioned within the control valve body 22 of the transmission 14.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A transmission hydraulic control system for actuating at least one torque transmitting device in a transmission for an automobile, the hydraulic control system comprising:
a hydraulic circuit in fluid communication with the at least one torque transmitting device;
a transmission pump in fluid communication with the hydraulic circuit and adapted to provide pressurized hydraulic fluid to the hydraulic circuit;
an accumulator including:
an inner volume in fluid communication with the hydraulic circuit, the inner volume having an annular cylindrical shape concentric with a center-line of the transmission;
an annular piston positioned within the inner volume, the piston moveable between a first position and a second position; and
a spring adapted to bias the piston to the first position;
a valve mechanism positioned within a control valve body of the transmission between the hydraulic circuit and the accumulator, the valve mechanism adapted to selectively allow fluid communication between the inner volume of the accumulator and the hydraulic circuit, and to prevent fluid communication between the inner volume of the accumulator and the hydraulic circuit, wherein the valve mechanism allows the pressurized hydraulic fluid to enter the inner volume of the accumulator when the transmission pump is running, the valve mechanism holds pressurized hydraulic fluid within the inner volume of the accumulator when the transmission pump is not running, and the valve mechanism selectively releases pressurized hydraulic fluid from the inner volume of the accumulator to the hydraulic circuit; and
a controller adapted to send a start/stop signal to the valve mechanism to selectively actuate the valve mechanism.

2. The hydraulic control system of claim 1, wherein the valve mechanism includes a first control device and a second control device, the first control device adapted to allow pressurized hydraulic fluid to enter the inner volume of the accumulator from the hydraulic circuit, the second control device adapted to selectively allow pressurized hydraulic fluid to flow from the inner volume of the accumulator to the hydraulic circuit.

3. (canceled)

4. The hydraulic control system of claim 2 wherein the first control device is a one-way ball check valve that allows fluid communication from the hydraulic circuit to the accumulator and prevents fluid communication from the accumulator to the hydraulic circuit.

5. The hydraulic control system of claim 4, wherein the second control device is a selectively actuatable valve having an open condition for allowing fluid communication between the inner volume of the accumulator and the hydraulic circuit and a closed condition for preventing fluid communication between the accumulator and the hydraulic circuit.

6. The hydraulic control system of claim 5, wherein the second control device further comprises an on/off solenoid.

7. The hydraulic control system of claim 1, wherein the spring biases the piston to the first position with a biasing force, and wherein the pressurized hydraulic fluid within the hydraulic circuit when the transmission pump is running is sufficient to overcome the biasing force of the spring such that when pressurized hydraulic fluid enters the inner volume of the accumulator the piston moves from the first position to the second position.

8. The hydraulic control system of claim 7, wherein when the transmission pump is not running and the valve mechanism is selectively actuated to allow fluid communication between the inner volume of the accumulator and the hydraulic circuit, the biasing force of the spring pushes the piston from the second position to the first position and forces hydraulic fluid within the inner volume of the accumulator into the hydraulic circuit.

9. The hydraulic control system of claim 1, wherein the valve mechanism is a selectively actuated pressure locking solenoid that is positioned within a control valve body of the transmission.

10. (canceled)

11. A transmission hydraulic control system for actuating at least one torque transmitting device in a transmission for an automobile, the hydraulic control system comprising:
a hydraulic circuit in fluid communication with the at least one torque transmitting device;
a transmission pump in fluid communication with the hydraulic circuit and adapted to provide pressurized hydraulic fluid to the hydraulic circuit;
an accumulator including:
an inner volume in fluid communication with the hydraulic circuit, the inner volume having an annular cylindrical shape concentric with a center-line of the transmission;
an annular piston positioned within the inner volume, the piston moveable between a first position and a second position; and
a spring adapted to bias the piston to the first position; and
a valve mechanism positioned within a control valve body of the transmission between the hydraulic circuit and the accumulator, the valve mechanism adapted to selectively allow fluid communication between the inner volume of the accumulator and the hydraulic circuit, and to prevent fluid communication between the inner volume of the accumulator and the hydraulic circuit, and
a controller adapted to send a start/stop signal to the valve mechanism to selectively actuate the valve mechanism, wherein:
when the transmission pump is running and the valve mechanism is selectively actuated to allow fluid communication between the hydraulic circuit and the inner volume of the accumulator, pressurized hydraulic fluid entering the inner volume of the accumulator is sufficient to overcome the biasing force of the spring and move the piston from the first position to the second position, increasing the capacity of the inner volume of the accumulator; and
when the transmission pump stops running the valve mechanism is actuated to prevent fluid communication between the hydraulic circuit and the inner volume of the accumulator, and pressurized hydraulic fluid is held within the inner volume of the accumulator; and
when the transmission pump is not running and the valve mechanism is selectively actuated to allow fluid communication between the hydraulic circuit and the inner volume of the accumulator, the biasing force of the spring pushes the piston from the second position to the first position and forces pressurized hydraulic fluid within the inner volume of the accumulator into the hydraulic circuit.

12. The hydraulic control system of claim 11, wherein the valve mechanism includes a first control device and a second control device, the first control device adapted to allow pressurized hydraulic fluid to enter the inner volume of the accumulator from the hydraulic circuit, the second control device adapted to selectively allow pressurized hydraulic fluid to flow from the inner volume of the accumulator to the hydraulic circuit.

13. The hydraulic control system of claim 12, wherein the first and second control devices are located within the control valve body of the transmission.

14. The hydraulic control system of claim 13 wherein the first control device is a one-way ball check valve that allows fluid communication from the hydraulic circuit to the accumulator and prevents fluid communication from the accumulator to the hydraulic circuit.

15. The hydraulic control system of claim 14, wherein the second control device is a selectively actuatable valve having an open condition for allowing fluid communication between the inner volume of the accumulator and the hydraulic circuit and a closed condition for preventing fluid communication between the accumulator and the hydraulic circuit.

16. The hydraulic control system of claim 15, wherein the second control device further comprises an on/off solenoid.

17. The hydraulic control system of claim 11, wherein the valve mechanism is a selectively actuated pressure locking solenoid that is positioned within a control valve body of the transmission.

18. (canceled)

19. A transmission hydraulic control system for actuating at least one torque transmitting device in a transmission for an automobile, the hydraulic control system comprising:
a hydraulic circuit in fluid communication with the at least one torque transmitting device;
a transmission pump in fluid communication with the hydraulic circuit and adapted to provide pressurized hydraulic fluid to the hydraulic circuit;
an accumulator including:
an inner volume in fluid communication with the hydraulic circuit, the inner volume having an annular cylindrical shape concentric with a center-line of the transmission;
an annular piston positioned within the inner volume, the piston moveable between a first position and a second position; and
a spring adapted to bias the piston to the first position; and
a selectively actuated pressure locking solenoid positioned within a control valve body of the transmission between the hydraulic circuit and the accumulator, the pressure locking solenoid adapted to selectively allow fluid communication between the inner volume of the accumulator and the hydraulic circuit, and to prevent fluid communication between the inner volume of the accumulator and the hydraulic circuit; and
a controller adapted to send a start/stop signal to the pressure locking solenoid to selectively actuate the valve mechanism, wherein:
when the transmission pump is running and the pressure locking solenoid is selectively actuated to allow fluid communication between the hydraulic circuit and the inner volume of the accumulator, pressurized hydraulic fluid entering the inner volume of the accumulator is sufficient to overcome the biasing force of the spring and move the piston from the first position to the second position, increasing the capacity of the inner volume of the accumulator; and
when the transmission pump stops running, the pressure locking solenoid is actuated to prevent fluid communication between the hydraulic circuit and the inner volume of the accumulator, and pressurized hydraulic fluid is held within the inner volume of the accumulator; and
when the transmission pump is not running and the pressure locking solenoid is selectively actuated to allow fluid communication between the hydraulic circuit and the inner volume of the accumulator, the biasing force of the spring pushes the piston from the second position to the first position and forces pressurized hydraulic fluid within the inner volume of the accumulator into the hydraulic circuit.

20. (canceled)
